(19) United States
(12) Patent Application Publication
(10) Pub. No.: US 2003/0069884 A1
(43) Pub. Date: Apr. 10, 2003

(54) Database structure

(76) Inventors: Ajit Nair, Framingham, MA (US); Tavit Ohanian, Waltham, MA (US)

Correspondence Address: LEFFERT JAY & POLGLAZE, P.A., P.O. BOX 581009, MINNEAPOLIS, MN, 55458-1009, US

(21) Appl. No.: 09/972,071

(22) Filed: Oct. 5, 2001

(51) Int. Cl. G06F 17/30

(52) U.S. Cl. 707/9

(57) ABSTRACT

A distributed provisioning system has a central database and a number of distributed provisioning servers. The provisioning servers connect to the central database for provisioning information, and for provisioning information for user access devices that need provisioning. The central database stores the provisioning information for the provisioning servers in uniquely accessible restricted access locations of the database, and maintains provisioning information for user access devices in a globally available location of the database.

The present invention relates generally to provisioning in a communications system, and more specifically to a provisioning database.

### BACKGROUND

Subnets within internet service provider (ISP) networks are ranges of internet protocol (IP) addresses. The subnets are utilized to allow effective assignment of users within an ISP so that the ISP does not overload one subnet over another subnet. The users among ISPs are often assigned to level loads among the various subnets of the ISP.

A provisioning system, such as a provisioning server, is responsible for provisioning, or configuring, user access devices such as cable modems (CM), media termination adapters (MTA), and customer provided equipment (CPE). The provisioning system accomplishes this by generating configuration files from a configuration information database or the like, knowing the type of device that is requesting access. A provisioning system typically includes a dynamic host configuration protocol (DHCP) server having a processor, memory, and some type of mass storage such as a hard drive or the like, and a trivial file transfer protocol (TFTP) server. The provisioning system may be a single computer functioning as all of the elements, or may be multiple computers connected together to function as a provisioning system.

Typically, ISPs within a provisioning system have multiple subnets assigned to them. These subnets are used to level or balance the load among the ISP so that it can provide good quality service with acceptable speeds and available bandwidth. The subnets are also used to monitor and track user usage and the like.

Provisioning systems typically contain a provisioning server such as that described above, and a local database. The database contains information pertaining to configuration of the provisioning server and any user access devices such as cable modems, media termination adapters, and other customer provided equipment. The information is stored and retrieved locally. Each provisioning server in a network, which may have multiple provisioning servers, has its own local database. The databases therefore contain very similar information from one database to another.

There is a need in the art for an improved provisioning database.

### SUMMARY

In one embodiment, a provisioning database includes a first data structure containing provisioning information for a number of globally accessible configuration resources, and a second data structure containing provisioning information for a number of restricted configuration resources.

In another embodiment, a database includes a number of global components and a number of restricted components. The global components are accessible to any requester, and the restricted components are restricted access on a per request basis.

In yet another embodiment, a provisioning database includes a first portion having a number of stored and uniquely identified sets of provisioning information. Each of the sets is associated with one of a number of external provisioning server and is accessible only to its associated provisioning server. A second portion of the database has a number of stored sets of provisioning information for a number of external user access devices, each of the sets globally accessible for provisioning any of the external user access devices.

In still another embodiment, an access method for controlling access to a database having a global portion and a restricted portion includes identifying a host device requesting access to the restricted portion, allowing access to a subsection of the restricted portion containing provisioning information for the particular requesting host device, and allowing universal access to the global portion for provisioning a user access device.

In yet another embodiment, a provisioning method includes receiving a configuration request from a host at a provisioning database, identifying the host, and configuring the host using restricted access configuration information stored in the provisioning database.

In another embodiment, a method of storing provisioning information includes creating first and second storage portions of a provisioning database, storing configuration information for a number of user access devices in the first portion, and identifying the first portion for global access by any of a number of external servers. The method also includes storing configuration information for a number of external provisioning servers in the second portion, assigning each of the external provisioning servers a unique identifier, and tagging the configuration information for each of the external provisioning servers with the unique identifier for that particular provisioning server. When a request for configuration information in the restricted second portion is received, only the configuration information tagged with the unique identifier of the external provisioning server requesting configuration information is retrieved.

Other embodiments are described and claimed.

### BRIEF DESCRIPTION OF THE DRAWINGS

FIG. 1 is a block diagram of a provisioning system according to one embodiment of the present invention;

FIG. 2 is a diagram of a database structure according to one embodiment of the present invention;

FIG. 3 is a flow chart diagram of a method according to one embodiment of the present invention;

FIG. 4 is a flow chart diagram of a method according to another embodiment of the present invention; and

FIG. 5 is a block diagram of a computer on which embodiments of the present invention are practiced.

### DETAILED DESCRIPTION

In the following detailed description of the embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

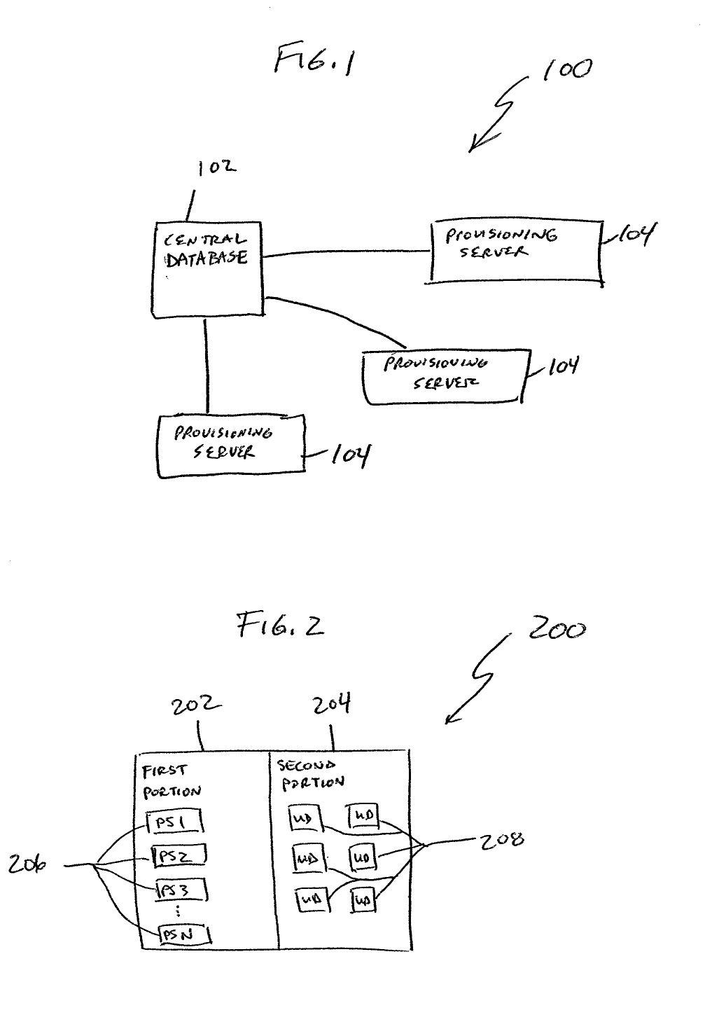

FIG. 1 is a block diagram of a network provisioning system 100 according to one embodiment of the present invention. System 100 comprises a central database 102 and a plurality of provisioning servers 104. Each of the provisioning servers 104 is connected for communication with the central database 102. The database in one embodiment is a standalone database. In another embodiment, the database is stored on a database server such as a structure query language (SQL) server or the like. In one embodiment, the directory server is a lightweight dynamic access protocol (LDAP) server. The central database contains provisioning information in the form of configuration information and the like for each provisioning server.

The database in one embodiment also contains a database section containing provisioning information in the form of configuration profiles and the like for user access devices. Such user access devices include by way of example only and not by way of limitation cable modems (CM), customer provided equipment (CPE), media termination adapters (MTA), and the like. In one embodiment, the database provisioning information for user access devices also contains information regarding various internet service providers (ISPs) accessible through the system 100, as well as information pertaining to service levels within the ISPs. The global information includes in one embodiment cable modem objects with associated media access control (MAC) addresses, service information, and all of the different service levels for the various CMs, MTAs, and CPEs that are defined.

In one embodiment, the database containing provisioning information for user access devices is global in nature. It is accessible to any of the multiple provisioning servers that have direct access to the directory server for provisioning. All of the information in the user access device provisioning database portion of the directory server is available to each provisioning server connected to the database. This allows each and every provisioning server to access the database for provisioning any user access device supported by the directory server. This further allows each provisioning server to allow open access to multiple different ISPs through one connection.

The database portion containing provisioning information for the various multiple provisioning servers which connect to the central database contains private or restricted information concerning the configuration of the various provisioning servers. In one embodiment, the information pertaining to each individual provisioning server is maintained under a specific identification number. This number is in one embodiment unique to the each provisioning server. In another embodiment, a number of standard configurations are maintained. These configurations allow for access to the various provisioning servers to be granted by a standard configuration profile. For example, certain types of provisioning servers have common configuration information. Theses servers in one embodiment each use the same configuration information. Therefore, each of these provisioning servers is given the identification number for the standard configuration most closely matching their configuration.

In another embodiment, each provisioning server has its own configuration profile maintained individually in the central database. When a particular provisioning server wishes to be provisioned, it transmits its unique identification number or code to the central database or to the system on which the database is stored, and is granted access to that part of the database that maintains specific configuration information for that particular provisioning server. In this way. many provisioning servers are configurable using a single central database, eliminating the need for a separate database for each provisioning server. Further, because the provisioning information for user access devices, ISPs, and service level agreements within ISPs are globally available, required storage space is reduced.

In operation, the system 100 functions as follows. A central database is maintained. The database in one embodiment contains two sections. The first section contains unique provisioning information for a number of provisioning servers which each connect to the single central directory server to obtain provisioning information. Such provisioning information includes by way of example only and not by way of limitation information for configuring a dynamic host configuration protocol (DHCP) server, a trivial file transfer protocol (TFTP) server, a SYSLOG, a DNS server, and the like. This provisioning information is in one embodiment coded uniquely to each provisioning server. That is, each provisioning server has its own configuration information that is available only to the specific provisioning server.

The second section of the database contains globally accessible information. This globally accessible information in one embodiment includes by way of example only and not by way of limitation configuration and profiling information for user access devices such as cable modems, media termination adapters, and other customer provided equipment that may need to be provisioned. Further, the globally accessible information in one embodiment includes information on multiple ISPs as well as service level agreement information for the various ISPs. The globally available information allows any provisioning server connecting to the central database to provision any user equipment that is contained in the database, regardless of which provisioning server is accessing the information.

In operation, a provisioning server connects to the central database, or system on which the database is stored, for provisioning. The provisioning server provides its unique identification code or number. This identification is used by the database to look up the specific provisioning information for the provisioning server that is attempting to connect to the system. The provisioning server is configured and provisioned according to its specifically stored configuration information. Such information includes by way of example only and not by way of limitation information for configuring DHCP, TFTP, DNS, SYSLOG, and the like.

Once the provisioning server is provisioned and configured, it is ready to provision various users who connect through a network to the provisioning server. These users have various access devices including CMs, MTAs, and other CPEs. When a request is made to the provisioning server for access to the network, the provisioning server obtains necessary information from the user access device that will allow the provisioning server to retrieve or generate a configuration file or profile for the user access device. The provisioning server makes in one embodiment an LDAP request to the central database or system which stores the database for provisioning information for the specific user access device. This information is globally stored in the central database. The provisioning information is transferred to the provisioning server in the form of a configuration profile or a configuration file, which is used to provision the user access device.

The single central database allows the multiple provisioning servers to allow access for, and to configure, numerous different user access devices without the need to maintain a local provisioning database. This frees local provisioning servers from maintaining a large database of potential user access devices that may rarely, if ever, be used in provisioning.

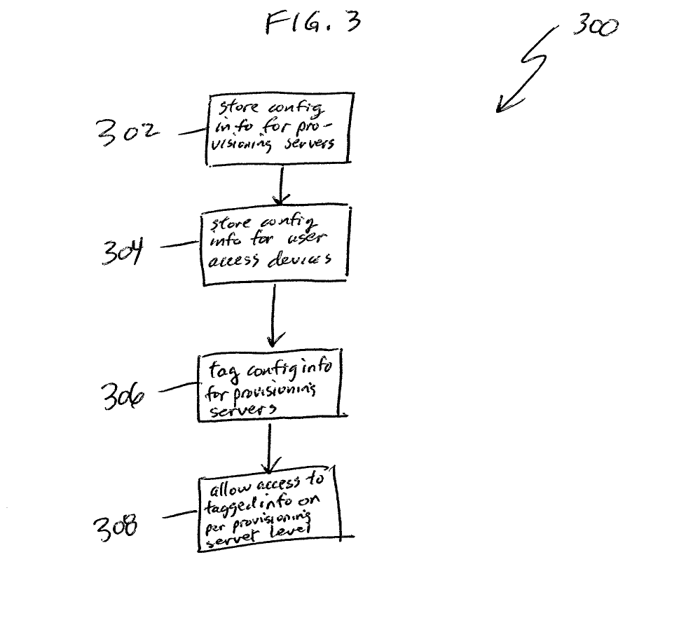

A embodiment of a database 200 used in various apparatus embodiments of the present invention is shown in FIG. 2. Database 200 comprises first portion 202 and second portion 204. In one embodiment, the first portion contains provisioning information for a plurality of provisioning servers such as provisioning servers 104 described above. The configuration information for each provisioning server is in one embodiment restricted to access by its particular provisioning server. That is, only the provisioning server for which the provisioning information is stored is allowed access to the information. Each provisioning server connecting to the database is allowed access only to its own provisioning information in the first portion 202.

The second portion 204 contains provisioning information for user access devices including but not limited to cable modems, media termination adapters, and other customer provided equipment. The second portion also contains information about various ISPs that are available through the database, as well as information about service levels for the various ISPs. In one embodiment, this information contained in the second portion 204 is accessible globally to any provisioning server that connects to the database. Any provisioning server with access to the database can therefore provision any user access device and any supported ISP and service levels through the database.

For example, if three different provisioning servers are using a single central database as the storehouse for provisioning information, for example database 200 described above, the first provisioning server has a first identification number. The provisioning information for the first provisioning server is tagged with the identification number for the first provisioning server. In one embodiment, each subnet for the various portions of the configuration information, such as those subnets for the DHCP server of the first provisioning server and the subnets for the TFTP server of the first provisioning server, is tagged with the identification number or code for the first provisioning server. Only the first provisioning server can therefore access the provisioning information for the first provisioning server stored on the central database. In turn, each provisioning server that connects to the central database for provisioning is assigned its own identification number or code. In another embodiment, multiple provisioning servers are assigned the same identification number of they are provisioned the same.

In one embodiment, the database 200 is stored in mass storage of a single central directory server of a system such as the system 100 described above.

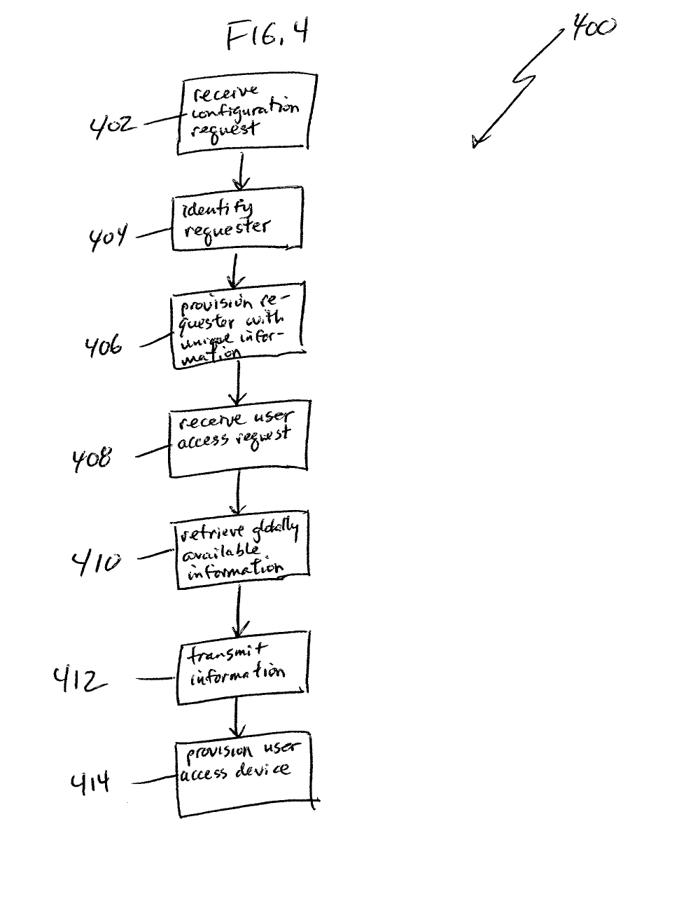

FIG. 3 is a flow chart diagram of a method 300 for provisioning at least one provisioning server connected to a central database Method 300 comprises storing configuration information for a plurality of provisioning servers in the central database in block 302, and storing configuration information for a plurality of user access devices in the central database in block 304. The central database in one embodiment is apportioned such as database 200 described above, that is with a first portion containing provisioning information for each separate provisioning server, tagged with a unique identifier in one embodiment to prevent unauthorized access to private provisioning information, and with a second portion containing globally available information for provisioning user access devices, and for assignment of ISPs and service agreements. In one embodiment, the configuration information for the plurality of provisioning servers is tagged with the unique identifier for each provisioning server in block 306, and access is allowed on a per provisioning server level to its own configuration information and also to all the configuration information for the plurality of user access devices in block 308.

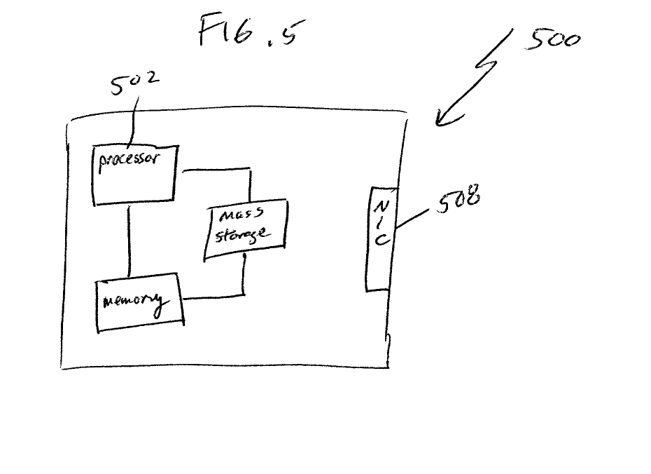

FIG. 4 is a flow chart diagram of a method 400 for operating a provisioning system. Method 400 operates in one embodiment on a provisioning system such as the system 100 described above, having a central database, which is stored remotely such as in a directory server, and a plurality of provisioning servers all connecting to the central database. Method 400 comprises receiving a configuration request from a provisioning server in block 402, and identifying the provisioning server in block 404. The provisioning server is identified in one embodiment through a unique identification number or code that is stored in the central database, and also is provided in the request by the provisioning server. Once the provisioning server request is directed to the proper provisioning information, the provisioning server is provisioned with its unique provisioning information in block 406.

A request from a user access device for provisioning is received at a provisioning server in block 408. The request is transmitted to the central database or to the system on which the central database is stored, such as a central directory server, and globally available information regarding provisioning the device is retrieved from the database in block 410. The configuration information is transmitted to the requesting provisioning server in block 412, and the user access device is provisioned with a configuration file or other provisioning file in block 414. General provisioning given a configuration profile or configuration file is known in the art and will not be described further herein.

FIG. 5 is a block diagram of a computer 500 on which embodiments of the present invention are practiced. Computer 500 comprises a processor 502 connected to a memory 504 and mass storage 506. Mass storage includes by way of example only and not by way of limitation, hard drives, disk drives, optical drives, magnetic media drives, CD- and DVD-ROM drives, and the like. The computer 500 has a network connection 508 such as a network interface card (NIC) or the like. In one embodiment, a computer program 510 is stored in storage for operation in memory by the processor. The program is implemented to cause the computer 500 to perform a method such as those methods described above. In one embodiment, the computer is part of a provisioning server for a communications network.

The methods shown in FIGS. 3, and 4 may be implemented in whole or in part in various embodiments in a machine readable medium comprising machine readable instructions for causing a computer such as is shown in FIG. 5 to perform the methods. The computer programs run on the central processing unit 502 out of main memory 504, and may be transferred to main memory from permanent storage 506 via disk drive or CD-ROM drive when stored on removable media or via a network connection 508 or modem connection when stored outside of the computer 500, or via other types of computer or machine readable media from which it can be read and utilized.

Such machine readable media may include software modules and computer programs. The computer programs may comprise multiple modules or objects to perform the methods in FIGS. 3 and 4 or the functions of various apparatuses of FIGS. 1, 2, and 5. The type of computer programming languages used to write the code may vary between procedural code type languages to object oriented languages. The files or objects need not have a one to one correspondence to the modules or method steps described depending on the desires of the programmer. Further, the method and apparatus may comprise combinations of software, hardware and firmware as is well known to those skilled in the art.

### CONCLUSION

A database for a distributed network of provisioning servers contains information that is globally accessible for user access devices such as CMs, MTAs, CPEs, ISPs and service levels, and contains information that is restricted on a per provisioning server basis for provisioning server configuration information.

A single central database therefore allows multiple provisioning servers to use it as central storage not only for provisioning server configuration information, but also for globally accessible information concerning provisioning and configuring a wide variety of user access devices.

The embodiments of the present invention allow a single central database to provision multiple distributed provisioning servers, as well as allow global access to provisioning and configuration information for numerous user access devices, eliminating the need for a local directory server.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A provisioning database, comprising:
a first data structure containing provisioning information for a plurality of globally accessible configuration resources; and
a second data structure containing provisioning information for a plurality of restricted configuration resources.

2. The provisioning database of claim 1, wherein the second data structure is restricted using identification codes.

3. The provisioning database of claim 1, wherein the plurality of globally accessible configuration resources includes configuration information for a plurality of user access devices.

4. A database having a plurality of global components and a plurality of restricted components, the global components accessible to any requester, and the restricted components having restricted access on a per request basis.

5. The database of claim 4, wherein the global components are provisioning information for a plurality of user access devices to a communications network.

6. The database of claim 4, wherein the restricted components are provisioning information for a plurality of provisioning servers uniquely identified to the database.

7. A provisioning database, comprising:
a first portion having a plurality of stored and uniquely identified sets of provisioning information, each of the sets associated with one of a plurality of external provisioning server and accessible only to its associated provisioning server; and
a second portion having a plurality of stored sets of provisioning information for a plurality of external user access devices, each of the sets globally accessible for provisioning any of the plurality of external user access devices.

8. The provisioning database of claim 7, wherein the second data structure is restricted using identification codes.

9. The provisioning database of claim 7, wherein the provisioning database is stored in a machine readable medium.

10. An access method for controlling access to a database having a global portion and a restricted portion, the method comprising:
identifying a host device requesting access to the restricted portion;
allowing access to a subsection of the restricted portion containing provisioning information for the particular requesting host device; and
allowing universal access to the global portion for provisioning a user access device.

11. The method of claim 10, wherein allowing access further comprises:
tagging each host device with a unique identifier;
storing configuration information on a per host device basis in the restricted portion; and
retrieving specific host information only upon matching a unique identifier with the per host device storage location.

12. A provisioning method, comprising:
receiving a configuration request from a host at a provisioning database;
identifying the host; and
configuring the host using restricted access configuration information stored in the provisioning database.

13. The method of claim 12, wherein configuring the host further comprises:
tagging specific host configuration information in a configuration database;
assigning a unique identifier to each of a plurality of hosts; and
retrieving configuration information associated with the unique identifier upon receiving a provisioning request from a host.

14. The method of claim 12, and further comprising:
assigning a unique identifier to each of a plurality of hosts;
storing configuration information for each of the plurality of hosts in a restricted access portion of the provisioning database; and
retrieving stored configuration information from the restricted access portion for a specific one of the plurality of provisioning servers when the specific provisioning server requests configuration.

15. A method of storing provisioning information, comprising:
creating first and second storage portions of a provisioning database;
storing configuration information for a plurality of user access devices in the first portion;
identifying the first portion for global access by any of a plurality of external servers;
storing configuration information for a plurality of external provisioning servers in the second portion;
assigning each of the plurality of external provisioning servers a unique identifier;
tagging the configuration information for each of the external provisioning servers with the unique identifier for that particular provisioning server; and
retrieving only the configuration information tagged with the unique identifier of an external provisioning server requesting configuration information.

16. A network system, comprising:
a central provisioning database; and
a plurality of provisioning servers, each provisioning server receiving specific configuration information from the central provisioning database for provisioning the provisioning server, and receiving global information for provisioning user access devices.
